(19) United States
(12) Patent Application Publication
(10) Pub. No.: US 2005/0128236 A1
(43) Pub. Date: Jun. 16, 2005

(54) Ink-jet recording apparatus and ink-jet recording method therefor

(75) Inventor: Toshihiro Fukasaka, Kawasaki-shi (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/996,310

(22) Filed: Nov. 22, 2004

(30) Foreign Application Priority Data
Dec. 15, 2003 (JP) 2003-417360

(51) Int. Cl. B41J 29/38

(52) U.S. Cl. 347/16

(57) ABSTRACT

An ink-jet recording apparatus using a full-line head is provided that achieves high-density and high-concentration printing without changing the conveying speed of a recording medium. To this end, when the dot-count value of at least one of a plurality of full-line ink-jet heads is greater than a predetermined value, the printing data is divided into two image patterns, each pattern having halved printing duty. First, an image pattern with one-half density is printed on the recording medium passed under the ink-jet heads. Then, the recording medium is conveyed to a perfecting reversal mechanism and is re-conveyed onto a transfer belt where the other half image pattern is printed thereon.

### BACKGROUND OF THE INVENTION

1. Field of the Invention

The present invention relates to an ink-jet recording apparatus and ink-jet recording methods thereof, and in particular to an ink-jet recording apparatus having a plurality of full-line ink-jet recording heads including a recording-element array corresponding to the width of a recording medium and an ink-jet recording method using the apparatus.

2. Description of the Related Art

Printers are known as information output devices for personal computers and other host devices for recording desired information, such as characters and images on recording medium, such as paper and films.

Recently, an ink-jet system is especially noticed among various recording systems of the printer. The reasons are non-contact recording, low running cost, easiness in colorizing, and low noise due to a non-impact system of the ink-jet system.

Among ink-jet recording apparatuses, a full-line recording apparatus is extensively being used. The full-line recording apparatus has a recording head having a recording element (nozzle) train corresponding to the recording width, so that recording is carried out while the recording medium being conveyed, speeding up recording all the more.

In such a full-line recording apparatus, a plurality of recording heads, with each head ejecting different color ink, are arranged in the conveying direction of the recording medium, so that ink can be simultaneously ejected from each recording head. By such a construction, the recording can be maintained without reducing its speed, even in the color-recording mode.

The recording head of such an ink-jet recording apparatus generally includes an energy generator that generates energy for ejecting ink from an ejection nozzle as ink droplets, an ink flow path accommodating the energy generator therein and also communicating with the ejection nozzle, and ink-accommodating means, such as an ink tank, for accommodating ink supplied to the energy generator via the ink flow path.

In recording apparatuses having functions of printers, copying machines, and facsimile machines, or recording apparatuses used as output devices of complex electronic instruments including a personal computer and a word processor and of work stations, images (including a character and a symbol) are recorded on a recording medium, such as paper and a plastic thin-film, based on recording information. Recently, in the recording apparatus, instead of a conventional dot matrix printer, a laser beam printer (abbreviated as an “LBP” below), an ink-jet printer (abbreviated as an “IJP” below), and a thermal printer have been used. More recently, a high-resolution and high-quality LBP capable of tone reproducing and a full-color IJP with photographic image quality have been used. As recording apparatuses have grown more sophisticated, in order to take full advantage of the features they provide, high quality recording medium, such as gloss paper, gloss film, coated paper, and media specially designed for photographic images have been introduced. Thus, recording apparatuses are required to support functions applicable to various diversified recording media, as well as support high-speed printing with an LBP level.

In a high-speed IJP, unlike a conventional IJP, a full-line ink-jet head is mounted so that printing is carried out by conveying the recording medium under the ink-jet head without moving the ink-jet head in a direction perpendicular to the conveying direction of the recording medium (see Japanese Patent Laid-Open No. 2001-105628, for example). As such, the recording medium can be continuously conveyed without conveying it intermittently, unlike a conventional IJP, so that the printing speed-up can be achieved. Since the number of nozzles for ejecting ink is increased considerably, the recording area per unit time is also increased to have a sufficient speed in accordance with the high-speed conveying of the recording medium.

However, in the full-line ink-jet head of the high-speed IJP, when nozzles are arranged along the width of A-4 size paper at a pitch of 600 DPI, the number of nozzles per one ink-jet head is 4800. In the case of the longitudinal length of A-4 size, there are 7200 nozzles. Moreover, if the resolution is doubled to 12000 DPI, the number of the nozzles is increased to twice as large as the above.

In the ink-jet head, especially in a thermal ink-jet head, a heater is provided in each nozzle as an energy generator for ejecting ink so that ink droplets are ejected from the nozzle by bubbles generated from ink heated by the heater.

The power consumption of each heater as the energy generator is very small. However, when several thousand heaters are provided in one ink-jet head, like in a full-line ink-jet head, if ink droplets are ejected from the entire nozzles simultaneously, an enormous sum of the power is required.

If the power supply for supplying such electric power is mounted on the IJP, the size of the IJP increases, as well as the cost.

In order to avoid this problem, a power control function can be provided. That is, the number of ink droplets ejected for one image is counted (dot count), and if the energy required is more than the available electric power, the power can suppressed in a predetermined value by thinning out the dots. However, in this case, thinning out the dots results in a decrease in density of the dots, and thus, the images to be originally printed cannot be obtained.

Also, there is a method that when the number of ink droplets ejected for one image is counted (dot count), and if the required energy is more than the available electric power, the conveying speed of the recording medium is reduced, so that the electric power consumed per unit time is suppressed within an available predetermined value. In this case, however, the control for providing a plurality of conveying speeds for conveying the recording medium is considerably complicated. Conveying accuracy varies for each conveying speed. As such, the printing quality is reduced when conveying speeds are change, as opposed to when an entire image is printed at a predetermined speed. In order to solve above problem, a conveying motor and conveying device must be structured so that the accuracies are constant for a plurality of conveying speeds.

### SUMMARY OF THE INVENTION

The present invention has been made in view of such problems, and in light of the problems, the present invention provides an ink-jet recording apparatus and an ink-jet recording method using the apparatus capable of achieving high-density printing while suppressing power cost using full-line ink-jet heads.

In order to achieve the above-described aspect of the present invention, an ink-jet recording apparatus according to a first aspect of the present invention includes an ink-jet recording head having a plurality of recording elements arranged along the entire width of a recording region of a recording medium; a conveying unit for conveying the recording medium to a position opposing the ink-jet recording head; a printing control unit for printing images on the recording medium conveyed to the position opposing the ink-jet recording head on the basis of printing data; and a circulating route for re-conveying the recording medium having images printed thereon by the printing control unit to the position opposing the ink-jet recording head, wherein the printing control unit divides the printing data corresponding to images to be printed on an identical surface of the recording medium into a plurality of printing data, and the printing control unit controls the conveying unit to convey the recording medium a plurality of times to the position opposing the ink-jet recording head via the circulating route so as to print the divided printing data.

An ink-jet recording apparatus according to a second aspect of the present invention includes an ink-jet recording head having a plurality of recording elements arranged along the entire width of a recording region of a recording medium; a conveying unit for conveying the recording medium to a position opposing the ink-jet recording head; a printing control unit for printing images on the recording medium conveyed to the position opposing the ink-jet recording head on the basis of printing data; and a circulating route for re-conveying the recording medium having images printed thereon by the printing control unit to the position opposing the ink-jet recording head, wherein the printing control unit can perform a first mode printing, in which an identical surface of the recording medium is printed by conveying the recording medium one time to the position opposing the ink-jet recording head, and a second mode printing, in which the identical surface of the recording medium is printed by conveying the recording medium a plurality of times to the position opposing the ink-jet recording head via the circulating route.

In an ink-jet recording method according to a third aspect of the present invention for printing images using an ink-jet recording head having a plurality of recording elements arranged along the entire width of a recording region of a recording medium, the ink-jet recording method includes the steps of dividing printing data corresponding to images to be printed on an identical surface of the recording medium into at least first-printing data and second-printing data; conveying the recording medium to a position opposing the ink-jet recording head; printing first images on the recording medium conveyed in the conveying step on the basis of the first-printing data; re-conveying the recording medium having the first images printed thereon in the printing step to the position opposing the ink-jet recording head via a circulating route; and printing second images on the recording medium conveyed in the re-conveying step on the basis of the second-printing data.

In an ink-jet recording method according to a fourth aspect of the present invention in an ink-jet recording apparatus including an ink-jet recording head having a plurality of recording elements arranged along the entire width of a recording region of a recording medium; a conveying unit for conveying the recording medium to a position opposing the ink-jet recording head; a printing control unit for printing images on the recording medium conveyed to the position opposing the ink-jet recording head on the basis of printing data; and a circulating route for re-conveying the recording medium having images printed thereon by the printing control unit to the position facing the ink-jet recording head, the ink-jet recording method includes the steps of selecting a mode to be performed from first-mode printing images on an identical surface of the recording medium by conveying the recording medium one time to the position opposing the recording head and second-mode printing images on the identical surface of the recording medium by conveying the recording medium a plurality of times to the position opposing the recording head via the circulating route; and printing on the recording medium according to the mode selected in the selecting step.

Further aspects, features and advantages of the present invention will become apparent from the following description of the preferred embodiments with reference to the attached drawings.

### BRIEF DESCRIPTION OF THE DRAWINGS

FIG. 1 is a structural drawing of an ink-jet recording apparatus.

FIG. 2 is a structural drawing of an ink-jet recording apparatus.

FIG. 3 is a plan view of a conveying unit of the ink-jet recording apparatus shown in FIGS. 1 and 2.

FIG. 4 is a structural drawing of a first embodiment according to the present invention.

FIGS. 5A and 5B are drawings showing printing duty.

FIG. 6 is a structural drawing of a second embodiment.

FIG. 7 is a plan view of. an ink-jet recording apparatus according to a third embodiment.

FIG. 8 is a plan view of an ink-jet recording apparatus according to the third embodiment.

FIG. 9 is a plan view of the ink-jet recording apparatus according to a fourth embodiment.

FIG. 10 is a plan view of an ink-jet recording apparatus according to a fifth embodiment.

FIG. 11 is a plan view of an ink-jet recording apparatus according to a sixth embodiment.

FIG. 12 is a plan view of an ink-jet recording apparatus according to a seventh embodiment.

FIG. 13 is a drawing showing an example of a resister pattern according to an eighth embodiment.

FIG. 14 is a plan view of an ink-jet recording apparatus according to a ninth embodiment.

FIG. 15 includes drawings showing the positional relationship between a recording medium and a line sensor according to tenth and eleventh embodiments.

FIG. 16 is a plan view of an ink-jet recording apparatus according to the eleventh embodiment.

FIGS. 17A and 17B are drawings showing printing duty according to a twelfth embodiment.

FIG. 18 is a structural drawing of a fourteenth embodiment.

FIG. 19 is a plan view of an ink-jet recording apparatus according to a fifteenth embodiment.

### DESCRIPTION OF THE EMBODIMENTS

Embodiments according to the present invention will be described below in detail with reference to the drawings.

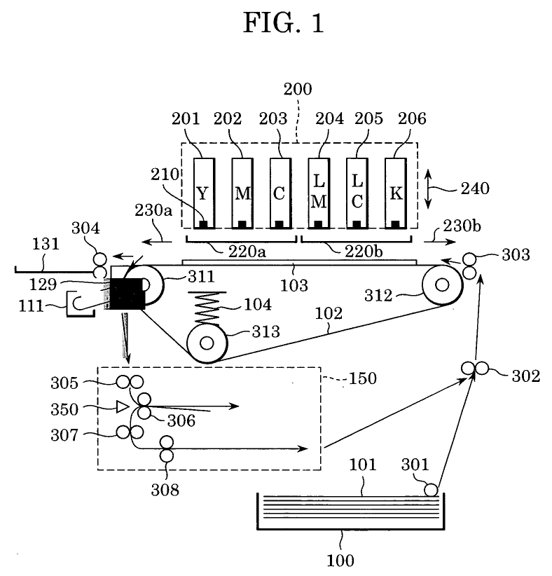

FIG. 1 shows a structure of a typical ink-jet recording apparatus. Referring to FIG. 1, a feeding mechanism of recording media 101 as printing paper, stored in a feed cassette 100, includes pick-up rollers 301 for picking up the recording medium 101 from the feed cassette 100, conveying rollers 302, register rollers 303, discharge rollers 304, which convey the recording medium 101 along a transfer route, a separation mechanism 129 for separating the recording medium 101 from a transfer belt 102, and a discharge tray 131 having the recording media 101 placed thereon.

The transfer belt 102 is supported by a driving roller 311, a follower roller 312, and a belt-tightening roller 313. The driving roller 311 is connected to a motor 111 and driven by the rotation of the motor 111 to drive the transfer belt 102. A spring 104 urges the belt-tightening roller 313 to apply a predetermined tension to the transfer belt 102. The transfer belt 102 is provided with a high-voltage power feeder 103 for applying high voltage to transfer the recording medium 101 by electro-static suction.

A head unit 200, arranged to oppose the transfer belt 102, includes six-color printing heads mounted thereon. The six-color printing heads include, arranged from left-to-right in FIG. 1, a sixth ink-jet head 201 for yellow (Y), a fifth ink-jet head 202 for magenta (M), a fourth ink-jet head 203 for cyan (C), a third ink-jet head 204 for light magenta (LM), a second ink-jet head 205 for light cyan (LC), and a first ink-jet head 206 for black (K). Each of the ink-jet heads 201 to 206 includes a nozzle part 210. In a non-printing mode, the nozzle parts 210 are capped with cap units 220a and 220b, which are slidable in a lateral direction (directions of arrows 230a and 230b in FIG. 1). The head unit 200 is movable in the vertical direction (arrow 240 in FIG. 1) in accordance with the opening and closing of the cap units 220a and 220b.

According to the present invention, a full-line ink-jet head is used. The full-line ink-jet head is defined as a head having a plurality of recording elements arranged along the entire width of a recording region of a recording medium. Generally, one recording apparatus is designed to use a plurality of kinds of recording media with different widths. Hence, the entire width of the recording region of a recording medium differs for recording media with different widths. Thus, according to the present invention, in order to support all of the recording media usable in the recording apparatus, a head with a plurality of recording elements arranged along the recording region of the recording medium with the maximum width is provided.

A perfecting reversal mechanism 150 includes precedent reversal-rollers 305, reversal rollers 306, subsequent reversal-rollers 307, perfecting rollers 308, and a path switcher 350, so that the recording medium 101 printed on the transfer belt 102 is reversed up-side down and is fed onto the transfer belt 102 again.

Operation of the ink-jet apparatus shown in FIG. 1 will now be described.

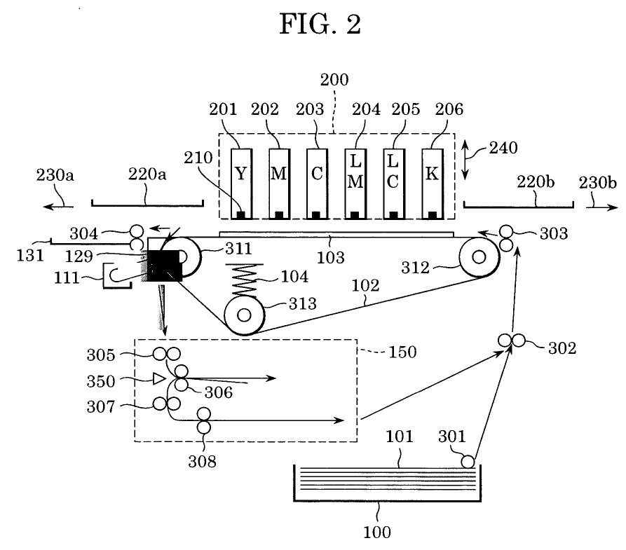

Upon initiating printing, the head unit 200 is elevated, the nozzle parts 210 are uncapped by laterally moving the cap units 220a and 220b, and the head unit 200 is then descended to the printing position. FIG. 2 shows the state when the head unit 200 is descended to the printing position. The conveying energy of the transfer belt 102 is applied from the motor 111 so that the transfer belt 102 starts rotating. The conveying energy of the conveying rollers 302, the register rollers 303, and the discharge rollers 304 is applied from another motor (not shown) to drive them.

The recording medium 101 picked up from the feed cassette 100 by the pick-up rollers 301 is fed onto the transfer belt 102 via the conveying rollers 302 and the register rollers 303. At this time, since a voltage is applied to the transfer belt 102 by the high-voltage power feeder 103 to be in a charged state, the transfer belt 102 electro-statically conveys the recording medium 101. The recording medium 101 is printed with ink ejected from the ink-jet heads 201 to 206 while passing under the ink-jet heads 201 to 206. The recording medium 101 passed under the ink-jet heads 201 to 206 is separated from the transfer belt 102 by the separation mechanism 129, and is discharged onto the discharge tray 131 after passing through the discharge rollers 304.

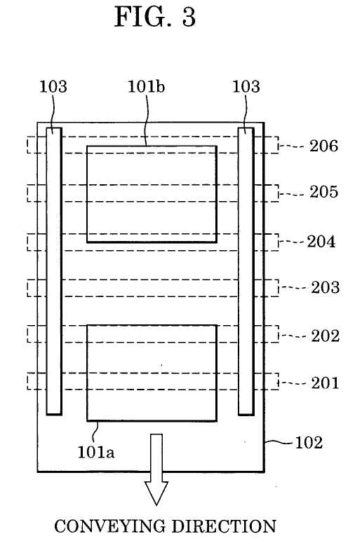

FIG. 3 is a top-down drawing of the ink-jet apparatus shown in FIGS. 1 and 2. As shown, recording media 101a and 101b placed on the transfer belt 102 are conveyed under the ink-jet heads 201 to 206 in the arrow conveying direction.

The operation during perfecting printing will now be described with reference FIG. 2.

The recording medium printed with the ink ejected from the ink-jet heads 201 to 206 and passing under the ink-jet heads 201 to 206 is conveyed to the perfecting reversal mechanism 150 via the separation mechanism 129. In the perfecting reversal mechanism 150, the recording medium is conveyed to the reversal rollers 306 after passing through the precedent reversal-rollers 305. After the trailing end of the recording medium 101 has passed the precedent reversal-rollers 305, transfer of the recording medium 101 is stopped. The transfer route is switched by the path switcher 350, to head for the reversal rollers 306. Then, by reversing the reversal rollers 306 from the direction before stopping, conveying of the recording medium 101 begins again. By this operation, a recording medium is reversed.

The recording medium 101 is stopped after being conveyed to the perfecting rollers 308. The timing of re-starting the transfer is determined by a space to a precedent recording medium 101, so that transfer of the recording medium 101 is started again after a predetermined waiting period. The re-started recording medium 101 is conveyed onto the transfer belt 102 again after passing through the conveying rollers 302 and the register rollers 303. Then, the recording medium 101 is separated from the transfer belt 102 by the separation mechanism 129 after the back face is printed to pass through the discharge rollers 304. Then, the recording medium 101 is discharged onto the discharge tray 131.

Exemplary embodiments according to the present invention are described below in detail with reference to the attached drawings. For discussion purposes, in the following embodiments, a printer will be used as an example of a recording apparatus using an ink-jet recording system.

In the following description, “printing” refers to not only to forming significant information, such as characters and figures, but also to widely used means for forming or processing images, designs, and patterns on a recording medium both significantly and insignificantly, i.e., not visually detectable by the human eye.

Also, the phrase “recording medium” in the following descriptions refers not only to paper used in a general recording apparatus but also to widely used ink-receivable materials, such as cloth, plastic films, metallic plates, glass, ceramics, lumber, and leather.

Furthermore, the term “ink” is understood as, liquid for forming images, designs, and patterns on a recording medium or for processing of a recording medium or ink, e.g., coagulation or insolubization of coloring materials in ink to be applied to the recording medium.

(First Embodiment)

A first embodiment according to the present invention will now be described.

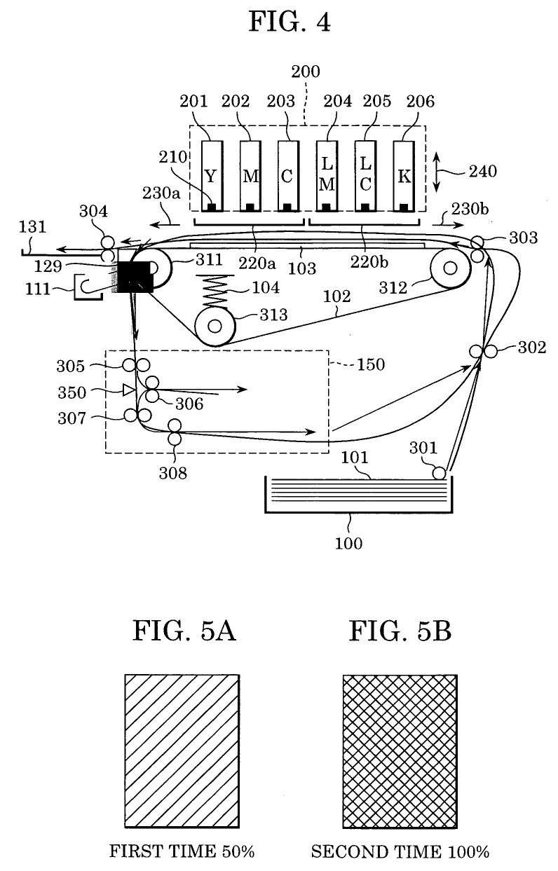

FIG. 4 is a schematic structural view of an ink-jet recording apparatus according to the first embodiment of the present invention. The ink-jet recording apparatus shown in the drawing is an IJP having a full-line ink-jet head mounted thereon as shown in FIGS. 1 and 2. In FIG. 4, the solid line arrows represent a transfer route of the recording medium 101.

The operation of the ink-jet recording apparatus according to the present embodiment will now be described.

First, the recording medium 101 is picked up from the feed cassette 100 by the pick-up rollers 301 and fed onto the transfer belt 102 via the conveying rollers 302 and the register rollers 303. At this time, the register rollers 303 serve to control the conveying timing of the recording medium 101 onto the transfer belt 102. That is, if the register rollers 303 stop, the conveyed recording medium 101 is stopped at the position of the register rollers 303. At this time, it is preferable that the recording medium 101 is stopped to form a loop with about several millimeters. Then, when the register rollers 303 start rotating, the recording medium 101 is transferred onto the transfer belt 102 and is printed with ink ejected from the ink-jet heads 201 to 206 while passing under the ink-jet heads 201 to 206. The ejection timing of the ink at this time is determined based on the value, in the case of the first ink-jet head 206, for example, of the distance between the register rollers 303 and the first ink-jet head 206 divided by the transfer speed of the recording medium 101. The other ink-jet heads 201 to 205 also eject ink at the timing calculated in the same way.

The printing data for the printing by the ink-jet heads 201 to 206 is supplied from an image-processing unit (not shown) for processing printing data corresponding to images to be printed. The image-processing unit has a dot-count function for counting the number of ink droplets ejected from each of the ink-jet heads 201 to 206. When the dot-count values of all the ink-jet heads 201 to 206 are lower than a predetermined value, the recording medium 101 passed under the ink-jet heads 201 to 206 is separated from the transfer belt 102 by the separation mechanism 129 and is discharged onto the discharge tray 131 after passing through the discharge rollers 304. That is, by one-time relative movement between the recording medium and the recording heads, printing is performed based on the printing data corresponding to images to be printed on the same surface of the recording medium.

On the other hand, when the dot-count value of at least one of the ink-jet heads 201 to 206 is greater than a predetermined value, in the image-processing unit, the printing data (referred to below as an “image pattern”) corresponding to images to be printed on the same surface of the recording medium is divided into two image patterns. The two divided image patterns are complementary to each other.

First, one-half image pattern is printed on the recording medium 101 passed under the ink-jet heads 201 to 206 (see FIG. 5A). Then, the recording medium 101 is separated from the transfer belt 102 by the separation mechanism 129 and is conveyed to the perfecting reversal mechanism 150. Within the perfecting reversal mechanism 150, the recording medium 101 is again conveyed onto the transfer belt 102 via the conveying rollers 302 and the register rollers 303 after passing through the precedent reversal-rollers 305, the path switcher 350, the subsequent reversal-rollers 307, and the perfecting rollers 308 in that order. The other half image pattern is printed (see FIG. 5B) on the recording medium 101, which is discharged onto the discharge tray 131 after passing through the discharge rollers 304. Thus, according to the present embodiment, with the printing data corresponding to images to be printed, the number of dots is counted for each head. When the counted value of at least one of a plurality of ink-jet heads exceeds a predetermined value, the image pattern is divided into two image patterns with about 50% duty so that printing is performed two times.

As described above, according to the present embodiment, in a printer having a full-multiple ink-jet head, printing can occur in two modes such that by conveying the recording medium to a position opposing the recording heads at one-time, the same surface of the recording medium is printed in a first mode. By conveying the recording medium to the position opposing the recording heads a plurality of times via the reversal mechanism, the same surface of the recording medium is printed in a second mode.

(Second Embodiment)

A second embodiment according to the present invention will now be described. The second embodiment differs from the first embodiment, in that the determination whether the image pattern is divided is based on the temperature of the ink-jet head instead of the dot count.

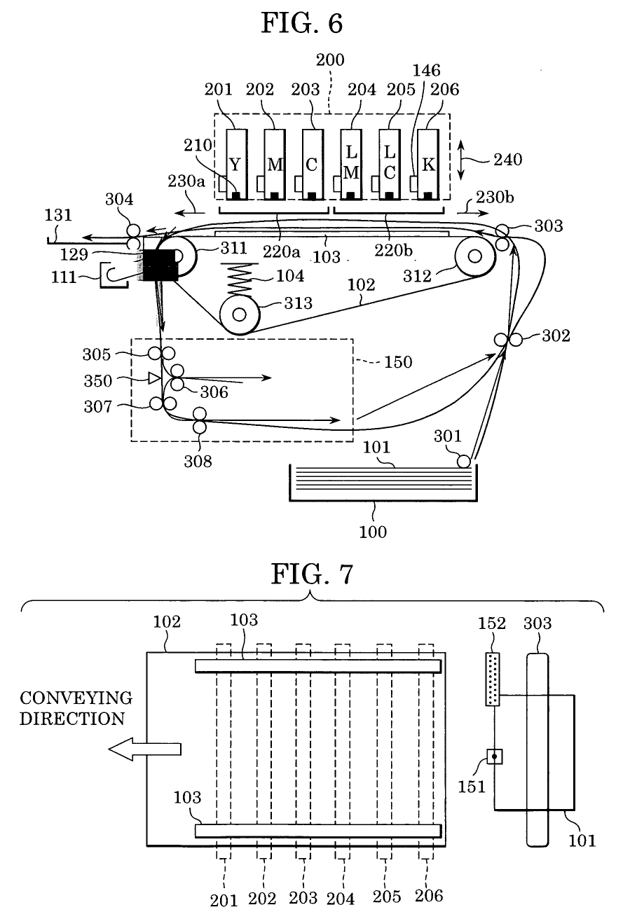

FIG. 6 is a schematic structural view of an ink-jet recording apparatus according to the second embodiment of the present invention, in which a temperature sensor 146 is provided in each of the ink-jet heads 201 to 206. The operation of the ink-jet recording apparatus according to the present embodiment will now be described.

The recording medium 101 picked up from the feed cassette 100 by the pick-up rollers 301 is fed to the register rollers 303 via the conveying rollers 302. At the position of the register rollers 303, the recording medium 101 is stopped to form a loop with about several millimeters. At this time, temperature sensors 146 measure the temperatures of the ink-jet heads 201 to 206. If the measured temperatures are lower than a predetermined value, the recording medium 101 passed under the ink-jet heads 201 to 206 is separated from the transfer belt 102 by the separation mechanism 129, and is discharged onto the discharge tray 131 after passing through the discharge rollers 304. That is, by one-time relative movement between the recording medium and the recording heads, printing is performed based on the printing data corresponding to images to be printed on the same surface of the recording medium.

On the other hand, when the ink-jet head temperature of at least one of the ink-jet heads 201 to 206 is greater than a predetermined value, in the image-processing unit, the printing data (image pattern) corresponding to images to be printed on the same surface of the recording medium is divided into two image patterns. First, one-half image pattern is printed on the recording medium 101 passed through under the ink-jet heads 201 to 206 (see FIG. 5A). Then, the recording medium 101 is separated from the transfer belt 102 by the separation mechanism 129 and is conveyed to the perfecting reversal mechanism 150. Within the perfecting reversal mechanism 150, the recording medium 101 is again conveyed onto the transfer belt 102 via the conveying rollers 302 and the register rollers 303 after passing through the precedent reversal-rollers 305, the path switcher 350, the subsequent reversal-rollers 307, and the perfecting rollers 308 in that order. The other half image pattern is printed (see FIG. 5B) on the recording medium 101, which is discharged onto the discharge tray 131 after passing through the discharge rollers 304. Thus, according to the present embodiment, with the temperature sensors 146, the temperatures of the ink-jet heads 201 to 206 are measured, and when the temperature of at least one of a plurality of ink-jet heads exceeds a predetermined value, the image pattern is divided into two image patterns with about 50% duty so that the printing is performed two times.

(Third Embodiment)

A third embodiment according to the present invention will now be described with respect to FIG. 7. FIG. 7 is a top-down drawing of an ink-jet recording apparatus according to the third embodiment of the present invention. The third embodiment differs from the above-described embodiments in that an X resister sensor 151 and a Y resister sensor 152 are provided between the register rollers 303 and the transfer belt 102.

According to the previously described embodiments, the recording medium 101 picked up from the feed cassette 100 by the pick-up rollers 301 is fed to the register rollers 303 via the conveying rollers 302. At the position of the register rollers 303, the recording medium 101 is stopped to form a loop with about several millimeters. Then, the ink ejection timings of the ink-jet heads 201 to 206 are determined by the initiating timing of the register rollers 303.

On the other hand, according to the present embodiment, nozzles and the ink ejecting timings of the ink-jet heads 201 to 206 are determined by the X resister sensor 151 and the Y resister sensor 152.

The X resister sensor 151 detects the leading edge of the conveyed recording medium 101 to detect the resister in the transfer direction (referred to as an X-resister below). The ink-ejecting timing is determined based on the value, in the case of the ink-jet head 206, of the distance between the X resister sensor 151 and the ink-jet head 206 divided by the transfer speed of the recording medium 101. The other ink-jet heads 201 to 205 also eject ink at the timing calculated in the same way. As such, the ejection timing is controlled to print images on the recording medium 101 at a predetermined position in the X-resister direction.

The Y resister sensor 152 then detects the ink-jet head in a nozzle row direction perpendicular to the transfer direction (referred to as a Y-resister below). The Y resister sensor 152 is driven by a Y-resister motor (not shown) in the Y-resister direction to detect the recording medium 101 in the Y-resister direction. The nozzle ejecting ink is controlled so that images to be printed can be printed on the recording medium 101 at a predetermined position in the Y-resister direction by shifting the nozzle position ejected from the ink-jet heads 201 to 206 by the detected value in the Y-resister direction. It is preferable that the Y resister sensor 152 have a detection accuracy of the nozzle pitch of the ink-jet head or more (e.g., in the case of 600 DPI, about 40 μm) by being minutely driven with a pulse motor.

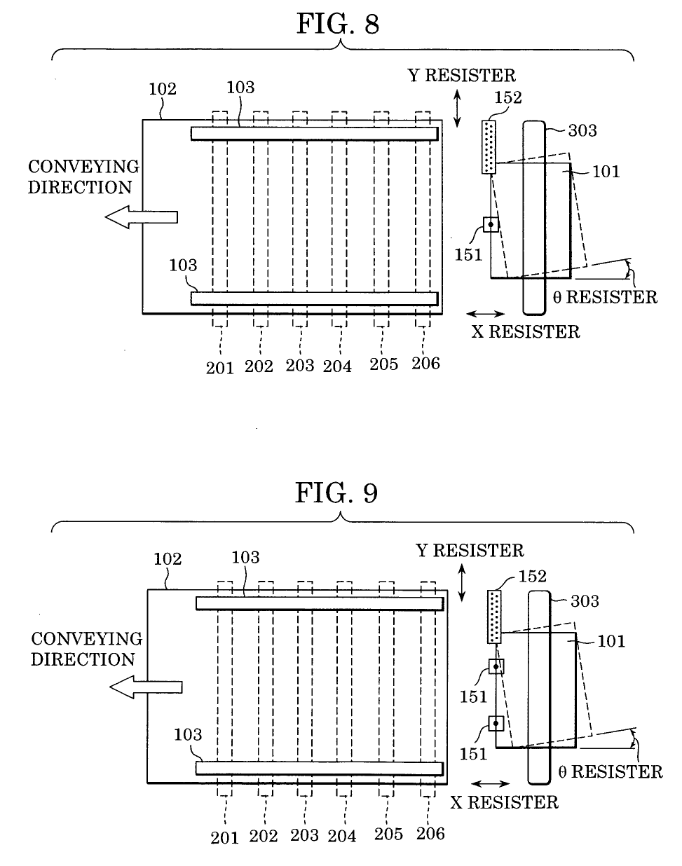

It is preferable that the X resister sensor 151 be positioned in the center of the transfer route. The Y resister sensor 152, as shown in FIG. 8, can detect not only the X-resister and the Y-resister but also a θ resister by detecting the Y-resister while the recording medium 101 passes. It is preferable that the sampling by the Y resister sensor 152 at this time be performed with a transfer speed of 400 mm/s, a resolution in the X-resister direction of 1200 DPI (about 20 μm), and a frequency of 20 kHz.

(Fourth Embodiment)

A fourth embodiment according to the present invention will now be described.

FIG. 9 is a top-down drawing of an ink-jet recording apparatus according to the fourth embodiment of the present invention. The fourth embodiment differs from the third embodiment in that the two X resister sensors 151 are provided between the register rollers 303 and the transfer belt 102.

According to the third embodiment, the θ resister is detected by the Y resister sensor 152. The θ resister is also detected by providing the two X resister sensors 151 in parallel with the ink-jet heads 201 to 206.

The X resister sensor 151 detects the leading edge of the conveyed recording medium 101 to detect the X-resister. At this time, if there is no shift in the θ-resister of the recording medium 101, the two X resister sensors 151 detect the recording medium 101 simultaneously. Conversely, if there is a time shift in detecting the recording medium 101 by the two X resister sensors 151, the θ shift exists. At this time, the shift is calculated from the distance between the two X resister sensors 151 and the time difference of detecting the recording medium 101. The X-resister may also be detected using only any one of the two X resister sensors 151. The Y-resister is detected when the recording medium 101 arrives at the Y resister sensor 152 using the Y resister sensor 152.

As a result of detecting the X-resister, the Y-resister, and the θ-resister, as shown in FIGS. 5A and 5B, the shift in the printing position can be eliminated in the first and the second printing by correcting the printing data in the image processing unit so as to determine the nozzle and the ejection timing of the ink-jet heads 201 to 206.

(Fifth Embodiment)

A fifth embodiment according to the present invention will be described.

FIG. 10 is a top-down drawing of an ink-jet recording apparatus according to the fifth embodiment of the present invention. The fifth embodiment differs from the previously described embodiments is that an area sensor 153 is provided between the register rollers 303 and the transfer belt 102 instead of the X resister sensor 151 and the Y resister sensor 152.

The area sensor 153 has a function for picturing surface images with a CCD so as to pick up images of one end of the recording medium 101 conveyed by the register rollers 303. The image timing is determined by the distance between the register rollers 303 and the area sensor 153, and the conveying speed. From the pictured images, the positional displacement to an ideal position of the recording medium 101 is calculated by comparing the practically imaged recording medium 101 with the ideal position of the recording medium 101 in a pattern recognition processing unit (not shown). The calculated displacement includes the X-resister, the Y-resister, and the θ-resister. From the detected results of the X-resister, the Y-resister, and the θ-resister, the printing data are corrected in the image processing unit so as to determine the nozzle and the ink-eject timing of the ink-jet heads 201 to 206, so that the recording medium 101 can be printed at a predetermined position.

The resolution of the area sensor 153 can be larger than that of the printing. The area sensor 153 may be arranged in front of the resister rollers or on the transfer belt 102.

(Sixth Embodiment)

A sixth embodiment according to the present invention will now be described.

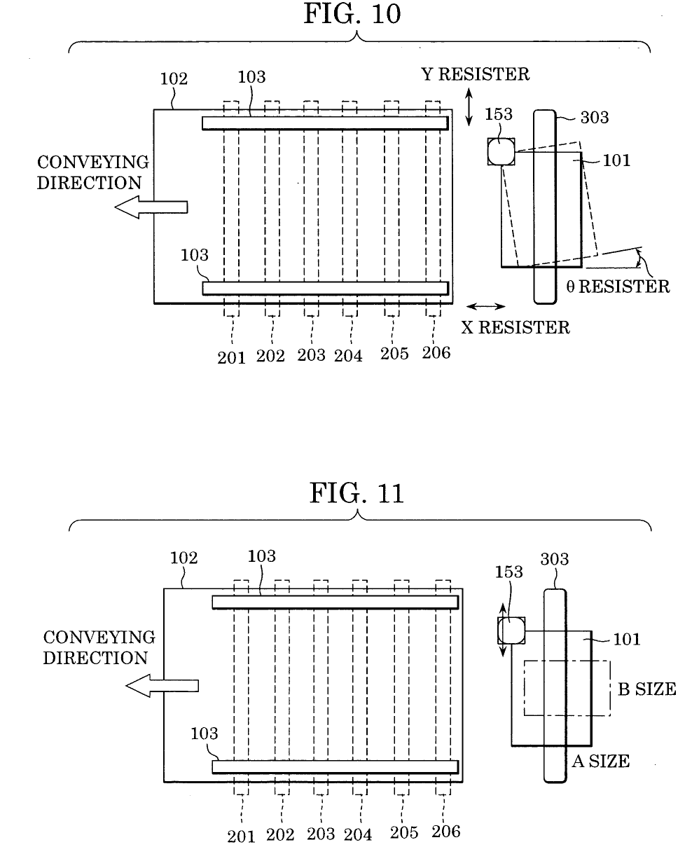

FIG. 11 is a top-down drawing of an ink-jet recording apparatus according to the sixth embodiment of the present invention. The sixth embodiment differs from the fifth embodiment in that the area sensor 153 is movable in a direction (arrow direction in FIG. 11) perpendicular to the transfer direction.

The area sensor 153 has a function for picturing surface images with a CCD so as to pick up images of one end of the recording medium 101 conveyed by the register rollers 303. When an A-size recording medium 101 is conveyed, the area sensor 153 picks up images of one end of the recording medium 101 at the position shown in FIG. 11. When a B-size recording medium 101 is conveyed, the area sensor 153 moves to a position where one end of the recording medium can be imaged in to pick up images thereof. The area sensor 153 picks up images to detect the X-resister, the Y-resister, and the θ-resister for each position. From the detected results of the X-resister, the Y-resister, and the θ-resister, the printing data are corrected in the image processing unit so as to determine the nozzle and the ink-eject timing of the ink-jet heads 201 to 206, so that the recording medium 101 can be printed at a predetermined position.

As such, by driving the area sensor 153 to pick up images of one end of the recording medium 101, a recording medium 101 of any size can be imaged. Since it is sufficient to pick up images of the least area possible for detecting the X-resister, the Y-resister, and the θ-resister, a small-sized, low cost CCD can be used. Moreover, since it is sufficient for detecting the X-resister, the Y-resister, and the θ-resister to pick up images of a small area, clear images with high resolution are possible.

(Seventh Embodiment)

A seventh embodiment according to the present invention will be described.

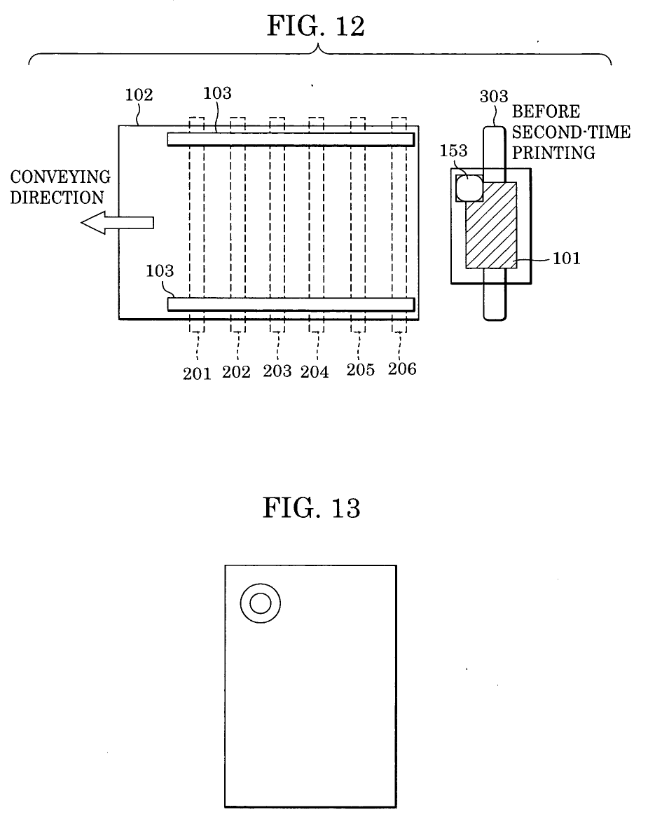

FIG. 12 is a top-down drawing of an ink-jet recording apparatus according to the seventh embodiment of the present invention. More specifically, FIG. 12 depicts a state that the recording medium is in just before being conveyed again to the transfer belt 102 after finishing the first time printing and passing through the perfecting reversal mechanism 150 when images to be printed on the same surface of the recording medium are printed two times. The seventh embodiment differs from the fifth embodiment in that the area sensor 153 can pick up the images printed on the recording medium 101 so as to detect the X-resister, the Y-resister, and the θ-resister therefrom.

The recording medium 101 picked up from the feed cassette 100 by the pick-up rollers 301 is fed onto the transfer belt 102 as the printing section via the conveying rollers 302 and the register rollers 303. At this time, the register rollers 303 serve to control the conveying timing of the recording medium 101 onto the transfer belt 102. That is, the register rollers 303 stop at the first time, and the conveyed recording medium 101 is stopped at the position of the register rollers 303. At this time, it is preferable that the recording medium 101 is stopped to form a loop with about several millimeters.

When the register rollers 303 start rotating, the recording medium 101 is transferred onto the transfer belt 102 and is printed with ink ejected from the ink-jet heads 201 to 206 while passing under the ink-jet heads 201 to 206. The ejection timing of the ink at this time is determined based on the value, in the case of the first ink-jet head 206, of the distance between the register rollers 303 and the first ink-jet head 206 divided by the transfer speed of the recording medium 101. The other ink-jet heads 201 to 205 also eject ink at the timing calculated in the same way. The printing data for the printing by the ink-jet heads 201 to 206 is supplied from an image-processing unit (not shown) for processing printing data.

When the number of counted dots of at least one of the ink-jet heads 201 to 206 is greater than a predetermined value, in the image-processing unit, the printing data (image pattern) corresponding to images to be printed on the same surface of the recording medium is divided into two image patterns. First, one-half image pattern is printed on the recording medium 101 passed under the ink-jet heads 201 to 206 (see FIG. 5A). Then, the recording medium 101 is separated from the transfer belt 102 by the separation mechanism 129 and is conveyed to the perfecting reversal mechanism 150. Within the perfecting reversal mechanism 150, the recording medium 101 is again conveyed onto the transfer belt 102 via the conveying rollers 302 and the register rollers 303 after passing through the precedent reversal-rollers 305, the path switcher 350, the subsequent reversal-rollers 307, and the perfecting rollers 308 in that order.

When the recording medium 101 is conveyed onto the transfer belt 102, the other half image pattern is printed thereon (see FIG. 5B) with ink ejected from the ink-jet heads 201 to 206 while the recording medium 101 passes under the ink-jet heads 201 to 206. At this time, the ink-ejecting timing from the ink-jet head is calculated by the area sensor 153 from the images printed on the recording medium 101. That is, the images printed on the recording medium 101 are picked up by the area sensor 153.

From the pictured images, the positional displacement to an ideal position of the recording medium 101 is calculated by comparing the practically imaged recording medium 101 with the ideal position of the recording medium 101. The calculated displacement includes the X-resister, the Y-resister, and the θ-resister. From the detected results of the X-resister, the Y-resister, and the θ-resister, the printing data are corrected in the image processing unit so as to determine the nozzle and the ink-eject timing of the ink-jet heads 201 to 206, so that the recording medium 101 can be printed at a predetermined position, which is the same position as in the first time printing.

According to the present embodiment, the printed images at the position imaged by the area sensor 153 are stored as the image data at the ideal position by trimming it off the first-time printed image pattern. The image data means the printed images pictured by the area sensor 153 based on the position from the register rollers 303 and the conveying speed.

According to the present embodiment, the X-resister, the Y-resister, and the θ-resister can be directly detected from the printed images, so that the printed images are directly corrected.

(Eighth Embodiment)

An eighth embodiment according to the present invention will now be described.

The eighth embodiment differs from the seventh embodiment in that a resister pattern is printed on the recording medium 101 during the first-time printing, and the area sensor 153 picks up the resister pattern printed on the recording medium 101 during the second-time printing so as to detect the X-resister, the Y-resister, and the θ-resister.

The recording medium 101 picked up from the feed cassette 100 by the pick-up rollers 301 is fed onto the transfer belt 102 as the printing section via the conveying rollers 302 and the register rollers 303. At this time, the register rollers 303 serve to control the conveying timing of the recording medium 101 onto the transfer belt 102. That is, the register rollers 303 stop at the first time, and the conveyed recording medium 101 is stopped at the position of the register rollers 303. At this time, it is preferable that the recording medium 101 be stopped to form a loop with about several millimeters. Then, when the register rollers 303 start rotating, the recording medium 101 is transferred onto the transfer belt 102 and is printed with ink ejected from the ink-jet heads 201 to 206 while passing under the ink-jet heads 201 to 206. Simultaneously, the resister pattern is also printed. The printing position of the resister pattern may be arbitrary as long as the position is the surface of the recording medium 101 where no images are printed and being imageable by the area sensor 153.

FIG. 13 shows an example of the resister pattern printed on the recording medium 101, in which the area sensor 153 picks up the resister pattern disposed on the upper left. The ink-ejecting timing from the ink-jet head is determined based on the value, in the case of the first ink-jet head 206, of the distance between the register rollers 303 and the first ink-jet head 206 divided by the transfer speed of the recording medium 101. The other ink-jet heads 201 to 205 also eject ink at the timing calculated in the same way. The printing data for the printing by the ink-jet heads 201 to 206 is supplied from an image-processing unit (not shown) for processing printing data.

When the number of counted dots of at least one of the ink-jet heads 201 to 206 is greater than a predetermined value, in the image-processing unit, the printing data (image pattern) corresponding to images to be printed on the same surface of the recording medium is divided into two image patterns. First, one-half image pattern is printed on the recording medium 101 passed under the ink-jet heads 201 to 206 (see FIG. 5A). Then, the recording medium 101 is separated from the transfer belt 102 by the separation mechanism 129 and is conveyed to the perfecting reversal mechanism 150. Within the perfecting reversal mechanism 150, the recording medium 101 is again conveyed onto the transfer belt 102 via the conveying rollers 302 and the register rollers 303 after passing through the precedent reversal-rollers 305, the path switcher 350, the subsequent reversal-rollers 307, and the perfecting rollers 308 in that order.

When the recording medium 101 is conveyed onto the transfer belt 102, the other half image pattern is printed thereon (see FIG. 5B) with ink ejected from the ink-jet heads 201 to 206 while the recording medium 101 passes under the ink-jet heads 201 to 206. At this time, the ink-ejecting timing from the ink-jet head is calculated from the resister pattern printed on the recording medium 101 by the area sensor 153. That is, the resister pattern printed on the recording medium 101 is picked up by the area sensor 153 to calculate the positional displacement to the ideal position. The calculated displacement includes the X-resister, the Y-resister, and the θ-resister. From the detected results of the X-resister, the Y-resister, and the θ-resister, the printing data are corrected in the image processing unit so as to determine the ink-eject timing by the ink-jet heads 201 to 206, so that the recording medium 101 can be printed at a predetermined position, which is the same position as in the first time printing.

(Ninth Embodiment)

A ninth embodiment according to the present invention will be described.

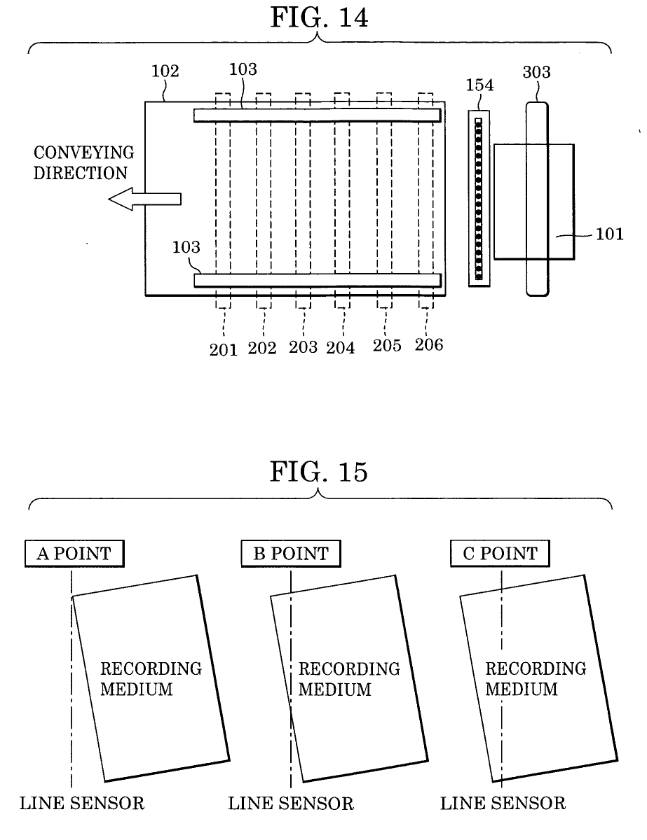

FIG. 14 is a top-down drawing of an ink-jet recording apparatus according to the ninth embodiment of the present invention. The ninth embodiment differs from the above-described embodiments in that a line sensor 154 is provided between the register rollers 303 and the transfer belt 102.

The line sensor 154 has a line CCD mounted thereon to pick up images of the recording medium 101 conveyed by the register rollers 303. FIG. 15 shows states that the recording medium 101 passes over the line sensor 154. The operation will be described herein on the presumption that a θ-shift exists. A-point is a state that an edge of the recording medium 101 begins being conveyed on the line sensor 154, which detects the recording medium 101. The following B-point is a state that parts of two sides of the recording medium 101 are passing over the line sensor 154. The images picked up by the line sensor 154 are stored in a pattern recognition processing unit (not shown), which recognizes the recording medium 101 as images. Generally, the size of the recording medium 101 is chosen in advance by selecting it in a printer driver, so that the X-resister, the Y-resister, and the θ-resister are calculated at this time. From the calculated results of the X-resister, the Y-resister, and the θ-resister, the printing data are corrected in the image processing unit so as to determine the nozzle and the ink-eject timing of the ink-jet heads 201 to 206, so that the recording medium 101 can be printed at a predetermined position.

(Tenth Embodiment)

A tenth embodiment according to the present invention will now be described.

The line sensor 154 has a line CCD mounted thereon to pick up images of the recording medium 101 conveyed by the register rollers 303. FIG. 15 shows states that the recording medium 101 passes over the line sensor 154. The operation will be described herein on the assumption that a θ-shift exists. A-point is a state that an edge of the recording medium 101 begins being conveyed on the line sensor 154, which detects the recording medium 101. The following B-point is a state that parts of two sides of the recording medium 101 are passing over the line sensor 154. C-point is a state that parts of two sides of the recording medium 101 are passing over the line sensor 154 after one side of the recording medium 101 passed thereon. When the recording medium 101 is conveyed to C-point, from the images picked up by the line sensor 154, the X-resister, the Y-resister, and the θ-resister are calculated in the pattern recognition processing unit (not shown). From the calculated results of the X-resister, the Y-resister, and the θ-resister, the printing data are corrected in the image processing unit so as to determine the nozzle and the ink-eject timing of the ink-jet heads 201 to 206, so that the recording medium 101 can be printed at a predetermined position.

(Eleventh Embodiment)

An eleventh embodiment according to the present invention will now be described.

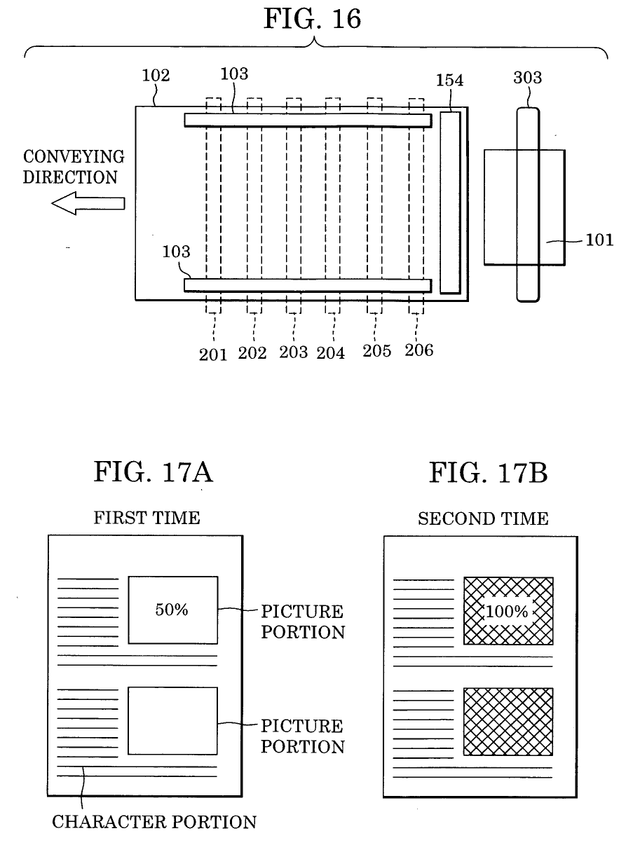

FIG. 16 is a top-down drawing of an ink-jet recording apparatus according to the eleventh embodiment of the present invention. The eleventh embodiment differs from the above-described embodiments is that the line sensor 154 is provided on the transfer belt 102.

The line sensor 154 has a line CCD mounted thereon to pick up images of the recording medium 101 conveyed by the register rollers 303. FIG. 15 shows states that the recording medium 101 passes over the line sensor 154. The operation will be described herein on the assumption that a θ-shift exists. A-point is a state that an edge of the recording medium 101 begins being conveyed on the line sensor 154, which detects the recording medium 101. The following B-point is a state that parts of two sides of the recording medium 101 are passing over the line sensor 154. C-point is a state that two sides of the recording medium 101 are passing over the line sensor 154 after one side of the recording medium 101 passed thereon. When the recording medium 101 is conveyed to C-point, from the images picked up by the line sensor 154, the X-resister, the Y-resister, and the θ-resister are calculated in the pattern recognition processing unit (not shown). From the calculated results of the X-resister, the Y-resister, and the θ-resister, the printing data are corrected in the image processing unit so as to determine the nozzle and the ink-eject timing of the ink-jet heads 201 to 206, so that the recording medium 101 can be printed at a predetermined position.

(Twelfth Embodiment)

A twelfth embodiment according to the present invention will now be described.

FIGS. 17A and 17B are drawings showing image patterns used in the twelfth embodiment of the present invention. The twelfth embodiment differs from the above-described embodiments is that image data to be printed on the recording medium 101 is divided into a character portion and a picture portion. In addition, only the picture portion is divided into two data with 50% duty so that the printing is performed two times, i.e., the first-time image pattern shown in FIG. 17A and the second-time image pattern shown in FIG. 17B.

The recording medium 101 picked up from the feed cassette 100 by the pick-up rollers 301 is fed onto the transfer belt 102 as the printing section via the conveying rollers 302 and the register rollers 303. At this time, the register rollers 303 serve to control the conveying timing of the recording medium 101 onto the transfer belt 102. That is, the register rollers 303 stop at the first time, and the conveyed recording medium 101 is stopped at the position of the register rollers 303. At this time, it is preferable that the recording medium 101 is stopped to form a loop with about several millimeters.

When the register rollers 303 start rotating, the recording medium 101 is transferred onto the transfer belt 102 and is printed with ink ejected from the ink-jet heads 201 to 206 while passing under the ink-jet heads 201 to 206. The ejection timing of the ink at this time is determined based on the value, in the case of the first ink-jet head 206, of the distance between the register rollers 303 and the first ink-jet head 206 divided by the transfer speed of the recording medium 101. The other ink-jet heads 201 to 205 also eject ink at the timing calculated in the same way.

The printing data for the printing by the ink-jet heads 201 to 206 is supplied from an image-processing unit (not shown) for processing printing data. The image-processing unit has a dot counting function to count dots ejected from each of the ink-jet heads 201 to 206. If the number of dot counts of at least one of the ink-jet heads 201 to 206 is a predetermined value or less, the recording medium 101 passed under the ink-jet heads 201 to 206 is separated from the transfer belt 102 by the separation mechanism 129 and is discharged onto the discharge tray 131 after passing through the discharge rollers 304.

If the number of dot counts of at least one of the ink-jet heads 201 to 206 is a predetermined value or greater, the image data to be printed is processed to divide it into the character portion and the picture portion by the image-processing unit. Among them, only the picture portion is further divided into two image patterns in the image-processing unit, each pattern having halved printing duty. On the recording medium 101 passing under the ink-jet heads 201 to 206, image patterns of the character portion and the picture portion with halved density are printed.

The recording medium 101 is then separated from the transfer belt 102 by the separation mechanism 129 and is conveyed to the perfecting reversal mechanism 150. Within the perfecting reversal mechanism 150, the recording medium 101 is again conveyed onto the transfer belt 102 via the conveying rollers 302 and the register rollers 303 after passing through the precedent reversal-rollers 305, the path switcher 350, the subsequent reversal-rollers 307, and the perfecting rollers 308 in that order. On the transfer belt 102, the image pattern of the other half-divided picture portion is printed on the recording medium 101, which is then discharged onto the discharge tray 131 after passing through the discharge rollers 304. Thus, according to the present embodiment, the dots of images to be printed are counted, and if the number of dot counts of at least one of a plurality of ink-jet heads is greater than a predetermined value, the image pattern is divided into the character portion and the picture portion, and only the picture portion is divided into two image patterns with 50% duty, so that the printing is performed two times.

(Thirteenth Embodiment)

A thirteenth embodiment according to the present invention will now be described.

The thirteenth embodiment differs from the twelfth embodiment in that the temperature of the ink-jet head, instead of the dot count, determines whether an image pattern is divided or not.

The recording medium 101 picked up from the feed cassette 100 by the pick-up rollers 301 is fed to the register rollers 303 via the conveying rollers 302. At the position of the register rollers 303, the recording medium 101 is stopped to form a loop with about several millimeters. At this time, temperature sensor 146 measures the temperatures of the ink-jet heads 201 to 206. If the temperature is a predetermined value or less, the recording medium 101 passed under the ink-jet heads 201 to 206 is separated from the transfer belt 102 by the separation mechanism 129, and is discharged onto the discharge tray 131 after passing through the discharge rollers 304.

If the temperature of at least one of the ink-jet heads 201 to 206 is a predetermined value or greater, the image data to be printed is processed to divide it into the character portion and the picture portion by the image-processing unit. Among them, only the picture portion is additionally divided into two image patterns in the image-processing unit, each pattern having halved printing duty. On the recording medium 101 passing under the ink-jet heads 201 to 206, image patterns of the character portion and the picture portion with halved density are printed.

The recording medium 101 is then separated from the transfer belt 102 by the separation mechanism 129 and is conveyed to the perfecting reversal mechanism 150. Within the perfecting reversal mechanism 150, the recording medium 101 is re-conveyed onto the transfer belt 102 via the conveying rollers 302 and the register rollers 303 after passing through the precedent reversal-rollers 305, the path switcher 350, the subsequent reversal-rollers 307, and the perfecting rollers 308 in that order. On the transfer belt 102, the image pattern of the other half-divided picture portion is printed on the recording medium 101, which is then discharged onto the discharge tray 131 after passing through the discharge rollers 304. Thus, the temperature sensor 146 measures the temperatures of the ink-jet heads 201 to 206, and if the temperature of at least one of a plurality of ink-jet heads is greater than a predetermined value, the image pattern is divided into the character portion and the picture portion. Only the picture portion is divided into two image patterns with 50% duty, so that the printing is performed in two times.

(Fourteenth Embodiment)

A fourteenth embodiment according to the present invention will now be described.

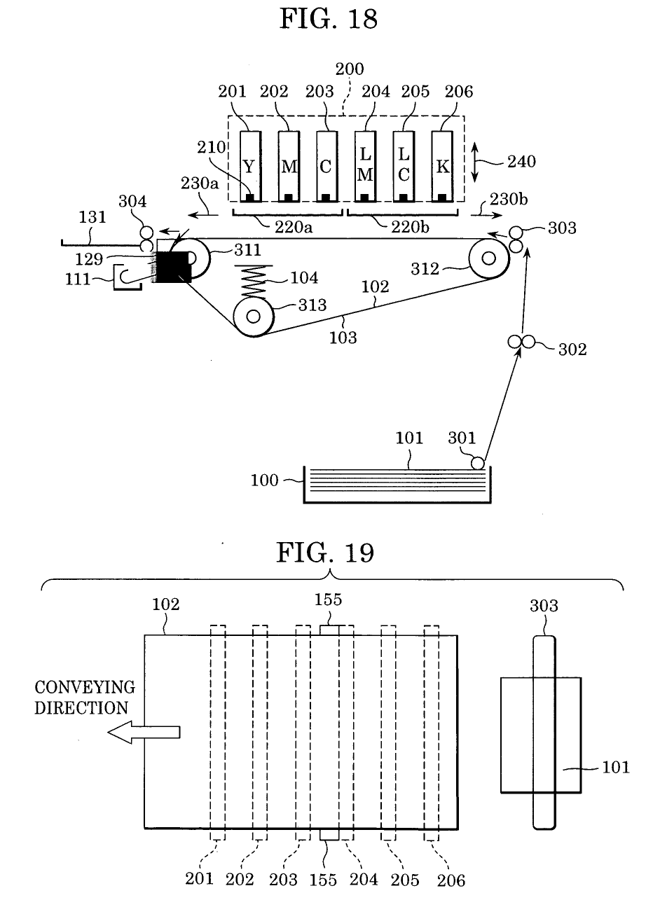

FIG. 18 is a schematic structural drawing of an ink-jet recording apparatus according to the fourteenth embodiment of the present invention. The fourteenth embodiment differs from the above-described embodiments in that the high-voltage feeding unit 103 is provided on the entire portion of the transfer belt 102 so that the recording medium 101 can be electro-statically attracted to the transfer belt 102 as a whole.

The recording medium 101 picked up from the feed cassette 100 by the pick-up rollers 301 is fed onto the transfer belt 102 as the printing section via the conveying rollers 302 and the register rollers 303. At this time, since the transfer belt 102 is in a charged state by the voltage application with the high-voltage feeding unit 103, the recording medium 101 is electro-statically attracted to the transfer belt 102. The recording medium 101 is printed with ink ejected from the ink-jet heads 201 to 206 while passing under the ink-jet heads 201 to 206. Since the entire transfer belt 102 is in an electro-statically attractive state, the recording medium 101 is then re-conveyed to under the ink-jet heads 201 to 206 while remaining in an attracted state to the transfer belt 102. The recording medium 101 passed under the ink-jet heads 201 to 206 is separated from the transfer belt 102 by the separation mechanism 129, and is discharged onto the discharge tray 131 after passing through the discharge rollers 304.

Thus, the recording medium 101 remains in the attracted state to the transfer belt 102 to be printed by the ink-jet heads. After finishing the entire printing, the recording medium 101 is separated from the transfer belt 102 by the separation mechanism 129, and is discharged onto the discharge tray 131.

(Fifteenth Embodiment)

A fifteenth embodiment according to the present invention will be described.

FIG. 19 is a drawing showing the fifteenth embodiment of the present invention. The fifteenth embodiment differs from the fourteenth embodiment in that a belt-leaning sensor 155 is provided in the transfer belt 102 for detecting the leaning of the transfer belt 102 in the Y-resister direction.

The recording medium 101 picked up from the feed cassette 100 by the pick-up rollers 301 is fed onto the transfer belt 102 as the printing section via the conveying rollers 302 and the register rollers 303. At this time, since the transfer belt 102 is in a charged state by the voltage application with the high-voltage feeding unit 103, the recording medium 101 is electro-statically attracted to the transfer belt 102. The recording medium 101 is printed with ink ejected from the ink-jet heads 201 to 206 while passing under the ink-jet heads 201 to 206. At this time, the printing position of the transfer belt 102 in the Y-resister direction is detected and stored using the belt-leaning sensor 155. Since the entire transfer belt 102 is in an electro-statically attractive state, the recording medium 101 is then re-conveyed to under the ink-jet heads 201 to 206 remaining in an attracted state to the transfer belt 102.

At this time, the printing position of the transfer belt 102 in the Y-resister direction is detected with the belt-leaning sensor 155 so as to compare it with the first-time printing position in the Y-resister direction. If there is no displacement between the first-time position and the second-time position, the printing is started as it is. On the other hand, if there is a displacement between the first-time position and the second-time position, by shifting the printing data in the Y-resister direction by the displacement, the second-time position is shifted so that the printing can be performed at the same position as that of the first-time. The recording medium 101 passed under the ink-jet heads 201 to 206 is separated from the transfer belt 102 by the separation mechanism 129, and is discharged onto the discharge tray 131 after passing through the discharge rollers 304.

Thus, by adding the belt-leaning sensor 155, the printing position in the Y-resister direction is detected and corrected so that images can be always printed at the same position in the Y-resister direction.

(Sixteenth Embodiment)

A sixteenth embodiment according to the present invention will now be described.

The sixteenth embodiment differs from the above-described embodiments in that the conveying means for conveying the recording medium 101 to under the ink-jet heads 201 to 206 becomes bidirectional.

The recording medium 101 picked up from the feed cassette 100 by the pick-up rollers 301 is fed onto the transfer belt 102 as the printing section via the conveying rollers 302 and the register rollers 303. At this time, since the transfer belt 102 is in a charged state by the voltage application with the high-voltage feeding unit 103, the recording medium 101 is electro-statically attracted to the transfer belt 102. The recording medium 101 is printed with ink ejected from the ink-jet heads 201 to 206 while passing under the ink-jet heads 201 to 206. After finishing the entire printing, and the trailing end of the recording medium 101 passed through the ink-jet head 201, the recording medium 101 is re-conveyed to under the ink-jet heads 201 to 206 by reversing the rotation of the transfer belt 102.

At this time, the recording medium 101 can be printed with ink ejected from the ink-jet heads 201 to 206 while the transfer belt 102 is reversing. In addition, the recording medium 101 can also be printed when the transfer belt 102 is normally rotated again after the belt is reversed until the leading end of the recording medium 101 passes through the ink-jet head 201. The recording medium 101 can also be printed with ink ejected from the ink-jet heads 201 to 206. The recording medium 101 passed through under the ink-jet heads 201 to 206 is separated from the transfer belt 102 by the separation mechanism 129, and is discharged onto the discharge tray 131 after passing through the discharge rollers 304.

Thus, by bi-directionally driving and controlling the transfer belt 102, the recording medium 101 can be conveyed to under the ink-jet heads 201 to 206, resulting in eliminating unnecessary additional passes through the transfer route.

(Other Embodiments)

According to the above-described embodiments, the printing data corresponding to the images to be printed on an identical surface of the recording medium is divided into two, and the printing is performed based on the two divided printing data by means of the double relative movements between the recording medium and the recording head. However, the number of divisions of the printing data and the number of the relative movements are not limited to two, and may be three or more.

Also, the example provided in the above-described embodiments includes recording medium supplied from one feed cassette. Alternatively, an ink-jet recording apparatus having a plurality of feed cassettes may incorporate the features of the present invention.

According to the above-described embodiments, reference values are used in comparing the number of dot counts and the temperature therewith. However, these values may be changed accordingly in accordance with the printing circumstances. Furthermore, combinations and changes in these values may be made within the scope of the invention.

According to the present invention, in the full-line ink-jet printer, a small power supply may be used, and high-density and high-concentration images can still be printed without changes in conveying speed and a halt of the recording medium.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation to encompass all such modifications and equivalent structures and functions.

This application claims priority from Japanese Patent Application No. 2003-417360 filed Dec. 15th, 2003, which is hereby incorporated by reference herein.

1. An ink-jet recording apparatus comprising:
an ink-jet recording head having a plurality of recording elements arranged along the entire width of a recording region of a recording medium;
a conveying. unit for conveying the recording medium to a position opposing the ink-jet recording head;
a printing control unit for printing images on the recording medium conveyed to the position opposing the ink-jet recording head on the basis of printing data; and
a re-conveyance route for re-conveying the recording medium having images printed thereon by the printing control unit to the position opposing the ink-jet recording head,
wherein the printing control unit divides the printing data corresponding to images to be printed on an identical surface of the recording medium into a plurality of printing data, and
wherein the printing control unit controls the conveying unit to convey the recording medium a plurality of times to the position opposing the ink-jet recording head via the re-conveyance route to print the divided printing data.

2. An ink-jet recording apparatus comprising:
an ink-jet recording head having a plurality of recording elements arranged along the entire width of a recording region of a recording medium;
a conveying unit for conveying the recording medium to a position opposing the ink-jet recording head;
a printing control unit for printing images on the recording medium conveyed to the position opposing the ink-jet recording head on the basis of printing data; and
a re-conveyance route for re-conveying the recording medium having images printed thereon by the printing control unit to the position opposing the ink-jet recording head,
wherein the printing control unit performs a first mode printing, in which an identical surface of the recording medium is printed by conveying the recording medium one time to the position opposing the ink-jet recording head, and a second mode printing, in which the identical surface of the recording medium is printed by conveying the recording medium a plurality of times to the position opposing the ink-jet recording head via the re-conveyance route.

3. The apparatus according to claim 2, wherein the control unit divides the printing data into character-portion data and image-portion data, and wherein the divided image-portion data is further divided into a plurality of image-portion data that are printed on the identical surface of the recording medium in the second mode.

4. The apparatus according to claim 1, further comprising counting means for counting the number of dots of the printing data,
wherein if the number of dots counted by the counting means is a predetermined value or more, the printing control unit divides the printing data into a plurality of data.

5. The apparatus according to claim 1, further comprising a head-temperature detector for detecting the temperature of the ink-jet recording head,
wherein the printing control unit divides the printing data into a plurality of data in accordance with the temperature detected by the head-temperature detector.

6. The apparatus according to claim 1, further comprising:
a recording-medium positional detector for detecting the position of a recording medium conveyed to a position opposing the recording head; and
correcting means for correcting the positional displacement of the recording medium based on the position detected by the recording-medium positional detector.

7. The apparatus according to claim 6, wherein the recording-medium positional detector detects the position of the recording medium re-conveyed via the re-conveyance route.

8. The apparatus according to claim 2, wherein the re-conveyance route is provided with a reversal mechanism for inverting the recording medium, and
wherein when a third mode is carried out in that both the surfaces of the recording medium are printed by conveying the recording medium two times to the position opposing the recording head, after a first surface of the recording medium is printed, the recording medium is inverted by the reversal mechanism so as to re-convey the inverted recording medium to the position opposing the recording head via the re-conveyance route so that a second surface of the recording medium is recorded.

9. An ink-jet recording apparatus comprising:
an ink-jet recording head having a plurality of recording elements arranged along the entire width of a recording region of a recording medium;
conveying means for conveying the recording medium to a position opposing the ink-jet recording head; and
a printing control unit for printing images on the recording medium conveyed to the position opposing the ink-jet recording head on the basis of printing data,
wherein if an identical surface of the recording medium is printed by conveying the recording medium two times to the position opposing the ink-jet recording head, the conveying means reverses the conveying direction of first-time conveying to second-time conveying.

10. An ink-jet recording method for printing images using an ink-jet recording head having a plurality of recording elements arranged along the entire width of a recording region of a recording medium, the method comprising the steps of:
dividing printing data corresponding to images to be printed on an identical surface of the recording medium into at least first-printing data and second-printing data;
conveying the recording medium to a position opposing the ink-jet recording head;
printing first images on the recording medium conveyed in the conveying step based on the first-printing data;
re-conveying the recording medium having the first images printed thereon in the printing step to the position opposing the ink-jet recording head via a re-conveyance route; and
printing second images on the recording medium conveyed in the re-conveying step based on the second-printing data.

11. An ink-jet recording method in an ink-jet recording apparatus comprising an ink-jet recording head having a plurality of recording elements arranged along the entire width of a recording region of a recording medium; a conveying unit for conveying the recording medium to a position opposing the ink-jet recording head; a printing control unit for printing images on the recording medium conveyed to the position opposing the ink-jet recording head on the basis of printing data; and a re-conveyance route for re-conveying the recording medium having images printed thereon by the printing control unit to the position opposing the ink-jet recording head, the method comprising the steps of:
selecting a mode to be performed from first-mode printing images on an identical surface of the recording medium by conveying the recording medium one time to the position opposing the recording head and second-mode printing images on the identical surface of the recording medium by conveying the recording medium a plurality of times to the position opposing the recording head via the re-conveyance route; and
printing images on the recording medium according to the mode selected in the selecting step.
